(19) United States
(12) Patent Application Publication
(10) Pub. No.: US 2025/0333263 A1
(43) Pub. Date: Oct. 30, 2025

(54) CABLE REEL ASSEMBLY

(71) Applicant: TAP&GO EV LTD., Richmond (CA)

(72) Inventor: John Mark ROBINSON, Richmond (CA)

(21) Appl. No.: 19/060,455

(22) Filed: Feb. 21, 2025

Related U.S. Application Data
(60) Provisional application No. 63/638,034, filed on Apr. 24, 2024.

(51) Int. Cl. B65H 75/44; B60L 53/18

(52) U.S. Cl. CPC B65H 75/4486; B60L 53/18; B65H 2701/34

(57) ABSTRACT

A cable reel assembly is disclosed. The cable reel assembly comprises a rotatable body having a first lateral end and an opposing second lateral end, and an outer wall shaped to receive a cable wound therearound, a reduction gear having a gear edge defining a plurality of teeth, arranged at the first or second lateral end of the rotatable body, an auxiliary shaft assembly comprising an elongate bar extending from a first end to an opposing second end, and a drive gear joined to the first end of the elongate bar. The drive gear is gearingly engagable with the gear teeth of the reduction gear. A drive motor is operatively coupled to the drive gear of the auxiliary shaft assembly to selectively drive a rotation of the drive gear, which in turn drives a rotation of the reduction gear, thereby rotating the rotatable body about a longitudinal axis thereof.

### CROSS-REFERENCE TO RELATED APPLICATION

This application claims the benefit under 35 U.S.C. § 119 of U.S. application No. 63/638,034 filed 24 Apr. 2024 and entitled CABLE REEL ASSEMBLY which is hereby incorporated herein by reference for all purposes.

### FIELD OF THE INVENTION

The invention pertains to cable management systems, in particular, those which include a cable reel assembly adapted for use in charging electric vehicles.

### BACKGROUND

Cable management systems which include rotatable cable reels are known in the art. There is a need in the electric vehicle charging industry for a reliable cable management system with a sufficiently large-sized reel so as to allow for delivery of high current supply. The present invention is directed to improved cable reel assemblies for managing electric vehicle charging cables.

### SUMMARY

The invention provides a cable reel assembly. In some embodiments, the cable reel assembly comprises a rotatable body having a first lateral end and an opposing second lateral end, and an outer wall shaped to receive a cable wound therearound, a reduction gear having a gear edge defining a plurality of teeth, arranged at the first or second lateral end of the rotatable body, an auxiliary shaft assembly comprising an elongate bar extending from a first end to an opposing second end, and a drive gear joined to the first end of the elongate bar. The drive gear is gearingly engagable with the gear teeth of the reduction gear. A drive motor is operatively coupled to the drive gear of the auxiliary shaft assembly to selectively drive a rotation of the drive gear, which in turn drives a rotation of the reduction gear, thereby rotating the rotatable body about a longitudinal axis thereof.

An example application of the cable reel assembly is in the field of charging electric vehicles. In such application, the cable reel assembly is housed in pedestal of an electric vehicle charging station. The cable comprises a charging cable having a first end electrically connected to the electric vehicle charging station, and a second end terminating in a charging connector. The charging connector is configured to operatively engage a charging port of an electric vehicle.

Further aspects of the invention and features of specific embodiments of the invention are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a prospective view of a cable reel assembly according to an example embodiment of the invention.

FIG. 2 is an exploded, prospective view of the FIG. 1 cable reel assembly.

FIG. 3 is a side elevational view of the FIG. 1 cable reel assembly.

FIG. 4 is a front elevational view of the FIG. 1 cable reel assembly.

### DETAILED DESCRIPTION

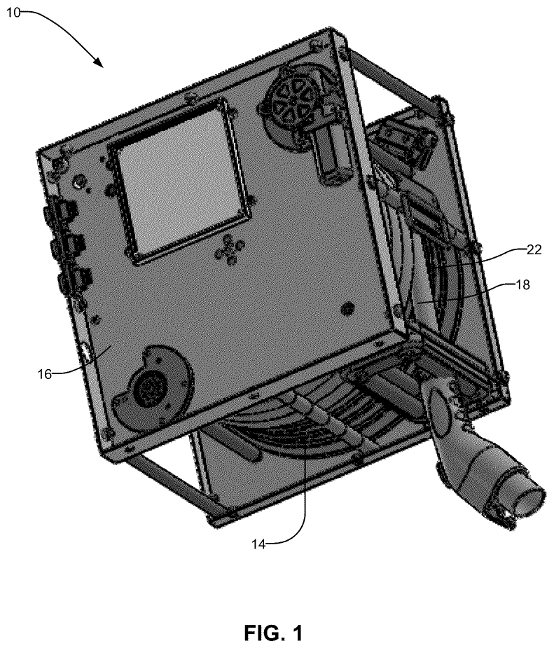

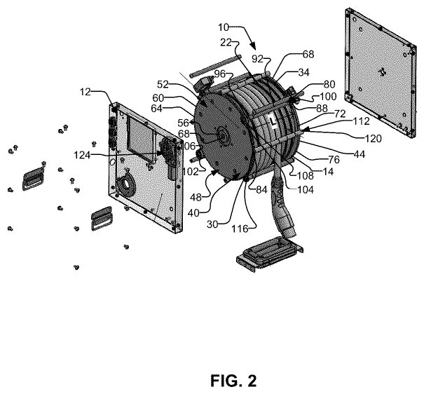

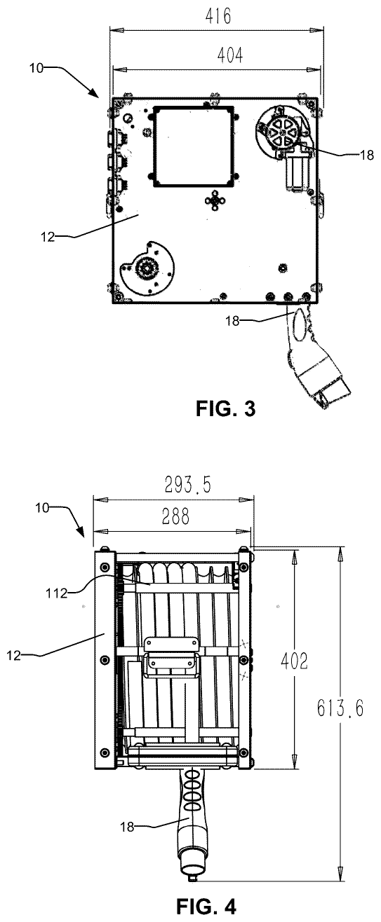

Referring to FIGS. 1 to 4, in one embodiment the apparatus of the invention is a cable reel assembly 10. The cable reel assembly 10 comprises a rotatable body 14 shaped to receive a cable 18 wound around an outer wall 22 thereof. The rotatable body 14 may be secured in a housing 16. The rotatable body 14 is rotatable about a longitudinal axis (L) thereof. In some embodiments, the rotatable body 14 defines an internal cavity (not shown) formed by the outer wall 22 of the body 14. The outer wall 22 has a first edge 30 and an opposing second edge 34. The cable 18 is arranged to wound around the outer wall 22 between the first and second edges 30, 34. In some embodiments, the rotatable body 14 comprises a reel or drum. In such embodiments, the outer wall 22 of the rotatable body 14 is cylindrical, or substantially cylindrical. The cross-sectional shape of the outer wall 18 is, in such embodiments, circular or substantially circular. However, outer wall 22 of the rotatable body 14 may comprise any other shape suitable to receive a cable 18 wound therearound.

In some embodiments, the outer wall 22 has grooves formed thereon. The width of the grooves is sized to fit the diameter of the cable 18 so as to allow the cable 18 to fit therein when the cable 18 is wound around the outer wall 22.

The rotatable body 14 has a first lateral end 40 and an opposing second lateral end 44. In some embodiments, a reduction gear 48 is arranged at the first and/or second lateral ends 40, 44. In some embodiments, the reduction gear 48 is mounted, secured, connected, affixed, or otherwise joined to the rotatable body 14. In some embodiments, the reduction gear 48 is integrally formed with the rotatable body 14. The reduction gear 48 may comprise a first surface 52 facing away from the internal cavity, and an opposing second surface (not shown) facing inwardly towards the internal cavity. The reduction gear 48 may comprise an opening 56 substantially communicatively aligned with the internal cavity of the rotatable body 14.

The reduction gear 48 comprises a gear edge 60 defining a plurality of gear teeth 64. The gear edge 60 of the reduction gear 48 may be arranged to extend outwardly from the first or second edge 30, 34 of the outer wall 22 of the rotatable body 14. In some example embodiments, the reduction gear 48 comprises a cylindrical gear body with the gear edge 60 being positioned circumferentially away from the first or second edge 30, 34 of a cylindrical outer wall 22 of the rotatable body 14.

In some embodiments, a shaft 68, defining a longitudinal shaft axis, is rotatably mounted within the internal cavity of the rotatable body. The shaft 68 may extend through the opening 56 of the reduction gear 48 and the internal cavity of the rotatable body 14 along the longitudinal axis (L) of the rotatable body 14. In some embodiments, the shaft 68 is arranged to extend through the entire longitudinal length of the rotatable body 14, from the first lateral end 40 to the second lateral end 44 of the rotatable body 14. The shaft 68 may be aligned substantially parallel with the longitudinal length of the rotatable body 14. The opening 56 of the reduction gear 48 and/or the internal cavity of the rotatable body 14 may be dimensioned to snuggly receive the shaft 68. In some embodiments, the shaft 68 secures the rotatable body 14 to the housing 16.

In some embodiments, an end plate 68 is arranged at the lateral end 40, 44 opposite to the lateral end 40, 44 at which the reduction gear 48 is arranged. In some embodiments, the end plate 68 is mounted, secured, connected, affixed, or otherwise joined to the rotatable body 14. In some embodiments, the end plate 68 is integrally formed with the rotatable body 14. The end plate 68 may comprise a first end plate surface 72 facing away from the internal cavity, and a second end plate surface (not shown) facing inwardly towards the internal cavity. The end plate 68 may comprise an end plate edge 76. In some embodiments, the perimeter of the end plate 68 is substantially the same as the perimeter of the reduction gear 48. In some embodiments, the radius of the end plate 68, defined by the distance from the center of the end plate to a point along the end plate edge 76, is substantially the same as the radius of the reduction gear 68, defined by the distance from the center of the reduction gear 68 to a point along the gear edge 60. In some embodiments, the reduction gear 48 and the end plate 68 are arranged co-axially.

In some embodiments, at least one auxiliary shaft assembly 80 is arranged to extend from a point 84 along the gear edge 60 of the reduction gear 48 to a point 88 along the end plate edge 76 of the end plate 68 along the longitudinal axis (L) of the rotatable body 14. In some embodiments, the at least one auxiliary shaft assembly 80 is substantially straight as the assembly 80 extends along the longitudinal axis (L) of the rotatable body 14, as viewed along the longitudinal axis (L) of the rotatable body 14. The at least one auxiliary shaft assembly 80 may be aligned substantially parallel to the longitudinal axis (L) of the rotatable body 14.

Each one of the at least one auxiliary shaft assembly 80 may comprise an elongate bar 92 extending from a first end 96 to an opposing second end 100, and a drive gear 102 mounted, secured, connected, affixed, or otherwise joined to the first or second end 96,100 of the elongate bar 92. In some embodiments, the drive gear 102 defines an aperture 106 dimensioned to snuggly receive a length of the elongate bar 92 at the first or second end 96, 100 of the elongate bar 92, thereby securing the drive gear 102 to the elongate bar 92. The drive gear 102 comprises a drive gear edge 104 defining a plurality of gear teeth 108. The at least one auxiliary shaft assembly 80 is positioned so as to allow the gear teeth 108 of the drive gear 102 to gearingly engage the gear teeth 64 of the reduction gear 48.

In some embodiments, a second reduction gear is arranged at the lateral end 40, 44 opposite to the lateral end 40, 44 at which the reduction gear 48 is arranged. The second reduction gear may be identical to the reduction gear 48.

In some embodiments, a second drive gear is mounted, secured, connected, affixed, or otherwise joined to the other one of the first or second end 96,100 of the elongate bar 92 opposite to the end 96, 100 to which the drive gear 102 is mounted. The second drive gear may be identical to the drive gear 102. In such embodiments, a second reduction gear may be arranged at the lateral end 40, 44 opposite to the lateral end 40, 44 at which the reduction gear 48 is arranged.

In some embodiments, the elongate bar 92 is in the form of a cylindrical rod. However, the elongate bar 92 may comprise any other suitable shapes and/or dimensions.

In some embodiments, the at least one auxiliary shaft assemblies 80 comprises a first auxiliary shaft assembly and a second auxiliary shaft assembly. The first and second auxiliary shaft assemblies may be identical. In some embodiments, the first and second auxiliary shaft assemblies are different. The first auxiliary shaft assembly and the second auxiliary shaft assembly may be arranged radially spaced apart from the outer wall 22 of the rotatable body 14. The first auxiliary shaft assembly and the second auxiliary shaft assembly are arranged spaced apart from one another around the outer wall 22. In some embodiments, the first auxiliary shaft assembly and the second auxiliary shaft assembly are arranged circumferentially spaced apart from one another, around the outer wall 22. In some example embodiments, the first and second auxiliary shaft assemblies are arranged in a diametrically opposed relationship.

In some embodiments, one or more support bars 112 are arranged spaced-apart from the at least one auxiliary shaft assembly 80, and from one another (in embodiments in which the assembly 10 comprises more than one support bar 112), around the outer wall 22 of the rotatable body 14. In some example embodiments, the one or more support bars 112 are arranged circumferentially spaced apart from the at least one auxiliary shaft assembly 80, and from one another (in embodiments in which the assembly 10 comprises more than one support bar 112), around the outer wall 22. Each of the one or more support bars 112 may extend from a first end 116 that may be joined to a point along the gear edge 60 of the reduction gear 48 to an opposing second end 120 that may be joined to a point along the end plate edge 76 of the end plate 68 along the longitudinal axis (L) of the rotatable body 14. In some embodiments, each of the one or more support bars 112 is substantially straight as the support bar 112 extends along the longitudinal axis (L) of the rotatable body 14, as viewed along the longitudinal axis (L) of the rotatable body 14. The one or more support bars 112 may be aligned substantially parallel to the longitudinal axis (L) of the rotatable body 14.

In some embodiments, the one or more support bars 112 is in the form of a cylindrical rod. However, the one or more support bars 112 may comprise any other suitable shapes and/or dimensions.

In use, when the cable 18 is wounded around the outer wall 22 of the rotatable body 14, the wounded cable 18 is positioned between the outer wall 22 and the at least one auxiliary shaft assemblies 80 and the one or more support bars 112 (if present). The at least one auxiliary shaft assemblies 80 and the one or more support bars 112 (if present) may be arranged to prevent the cable 18 from unraveling, or any undesired release from the rotatable body 14.

A drive motor 124 may be operatively coupled to the drive gear 102 of the at least one auxiliary shaft assembly 80 to selectively drive the rotation of the drive gear 102 and thus the elongate bar 92. The elongate bar 92 may be rotated about the longitudinal axis of the elongate bar 92. The rotation of the drive gear 102 rotates the reduction gear 48, thereby rotating the rotatable body 14 about the longitudinal axis (L) thereof. The rotation of the reduction gear 48 in a first direction (e.g., clockwise or counterclockwise) releases or dispenses the cable 18 that is wound around the rotatable body 14. The rotation of the reduction gear 48 in a second direction (e.g., clockwise or counterclockwise), opposite to the first direction, retracts or rewinds the cable 18 around the rotatable body 14.

In some embodiments, rotation of the reduction gear 48 and thereby the rotatable body 14 about the longitudinal axis (L) of the rotatable body 14 rotates the one or more support bars 112 about a longitudinal axis of the support bar 112.

In embodiments in which two auxiliary shaft assemblies 80 are provided, two drive motors 124 may be provided. Each of the drive motors 124 may be arranged to drive the rotation of one of the auxiliary shaft assemblies 80. In some embodiments, one of the drive motors may serve as an auxiliary power supply to the rotatable body 14. Such an auxiliary drive motor may be coupleable to the drive gear, i.e., the auxiliary drive motor may not be coupled to the drive gear all the time but only when necessary.

In some embodiments, a plurality of auxiliary shaft assemblies 80 and/or a plurality of drive motors 124 may be arranged to drive the rotation of the rotatable body 14. In some embodiments, one drive motor 124 may be arranged to drive the rotation of two or more auxiliary shaft assemblies 80.

In some embodiments, a drive motor may be operatively coupled to the shaft 68 being fitted within the internal cavity of the rotatable body 14 to drive the rotation of the shaft 68, and thereby the rotatable body 14.

In an example application, the cable reel assembly 10 is configured to store a charging cable. The charging cable may be adapted to charge an electric vehicle. The charging cable is electrically connected to an electric vehicle charging station (EVCS) at one end of the cable and terminates in a charging connector at the other end of the cable. The charging connector is configured to operatively engage a charging port of the electric vehicle. The electric vehicle charging station is connected to an electrical power source such as the local electric utility grid or a generator or a photovoltaic (PV) array, or any other source of electric power. The cable reel assembly 10 may be housed within a housing or pedestal of the electric vehicle charging station. The charging cable comprises one or more conductors for carrying a supply current between the electric vehicle charging station and the charging connector.

In some embodiments, the electric vehicle charging station comprises a control unit which is programmed and connected to control the operation of the cable reel assembly 10, including controlling the drive motor 124 to selectively actuate the rotation of the rotatable body 14. In one non-limiting example, the control unit of the charging station may be programmed to halt the release of the cable from the rotatable body 14 after a pre-determined timed connection interval between the charging connector and the charging port. In one non-limiting example, the control unit of the charging station may be programmed to automatically rewind the cable around the rotatable body 14 upon detection of a disengagement of the charging connector from the charging port. Suitable accessories such as one or more sensor systems and other accessories conventionally disposed in an electric vehicle charging station may be arranged in the electric vehicle charging station and/or the cable reel assembly 10.

Throughout the foregoing description and the drawings, in which corresponding and like parts are identified by the same reference characters, specific details have been set forth in order to provide a more thorough understanding to persons skilled in the art. However, well known elements may not have been shown or described in detail or at all to avoid unnecessarily obscuring the disclosure.

As will be apparent to those skilled in the art in the light of the foregoing disclosure, many alterations and modifications are possible in the practice of this invention without departing from the scope thereof. Accordingly, the description and drawings are to be regarded in an illustrative, rather than a restrictive, sense.

1. A cable reel assembly comprising:
a rotatable body (14) having a first lateral end (40), an opposing second lateral end (44), and an outer wall (22) shaped to receive a cable (18) wound therearound;
a reduction gear (48) having a gear edge (60) defining a plurality of gear teeth (64), arranged at the first or second lateral end of the rotatable body;
an auxiliary shaft assembly (80) comprising an elongate bar (92) extending from a first end (96) to an opposing second end (100), and a drive gear (102) joined to the first end of the elongate bar, wherein the drive gear is gearingly engagable with the gear teeth of the reduction gear; and
a drive motor (124) operatively coupled to the drive gear of the auxiliary shaft assembly to selectively drive a rotation of the drive gear, which in turn drives a rotation of the reduction gear, thereby rotating the rotatable body about a longitudinal axis thereof.

2. The cable reel assembly according to claim 1, further comprising an end plate (68) arranged at the first or second lateral end of the rotatable body opposite to the reduction gear.

3. The cable reel assembly according to claim 2, wherein the second end of the elongate bar is joined to an edge (76) of the end plate, and the first end of the elongate bar is joined to the gear edge of the reduction gear.

4. The cable reel assembly according to claim 1, wherein the auxiliary shaft assembly is arranged substantially parallel to the longitudinal axis of the rotatable body.

5. The cable reel assembly according to claim 2, wherein the end plate is co-axially aligned with the reduction gear.

6. The cable reel assembly according to claim 1, wherein the rotatable body defines an internal cavity formed by the outer wall thereof.

7. The cable reel assembly according to claim 6, further comprising a shaft (38) rotatably mounted within the internal cavity, wherein the shaft is arranged to extend from the reduction gear to the second lateral end of the rotatable body, along the longitudinal axis of the rotatable body.

8. The cable reel assembly according to claim 2, further comprising one or more support bars (112) arranged spaced-apart from the auxiliary shaft assembly, each one of the one or more support bars having a first end (116) joined to the gear edge of the reduction gear and an opposing second end (120) joined to the end plate edge.

9. The cable reel assembly according to claim 1, wherein the auxiliary shaft assembly comprises a first auxiliary shaft assembly and a second auxiliary shaft assembly, the first and second auxiliary shaft assemblies arranged spaced-apart from each other.

10. The cable reel assembly according to claim 9, wherein the first and second auxiliary shaft assemblies are arranged in a diametrically opposed relationship.

11. The cable reel assembly according to claim 10, wherein the one or more support bars are arranged between the first and second auxiliary shaft assemblies.

12. The cable reel assembly according to claim 1, further comprising a housing (16) dimensioned to secure the rotatable body therein.

13. An electric vehicle charging station comprising a pedestal dimensioned to house a cable reel assembly of claim 1, wherein the cable comprises a charging cable having a first end electrically connected to the electric vehicle charging station and a second end terminating in a charging connector, wherein the charging connector is configured to operatively engage a charging port of an electric vehicle.

14. The electric vehicle charging station of claim 13, further comprising a control unit configured to control a selective actuation of the drive motor.
